(19) United States
(12) Patent Application Publication
(10) Pub. No.: US 2007/0168609 A1
(43) Pub. Date: Jul. 19, 2007

(54) System and method for the migration of storage formats

(75) Inventor: Ahmad A. J. Ali, Austin, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/331,636

(22) Filed: Jan. 13, 2006

(51) Int. Cl. G06F 12/16; G06F 13/00

(52) U.S. Cl. 711/114; 711/165

(57) ABSTRACT

A system and method is disclosed for migrating configuration information for a storage array between storage controllers. At a shutdown, a first storage controller saves its configuration information to a storage location in or associated with the storage enclosure processor of the storage array. When a second controller is coupled to the storage array, the second storage controller attempts to recognize the configuration of the storage array. If the second storage controller is not able to recognize the configuration of the storage array, the second storage controller accesses the storage location for the storage location.

### TECHNICAL FIELD

The present disclosure relates generally to computer systems and information handling systems, and, more particularly, to a system and method for the migration of the format of a RAID volume, with data in place, across storage controllers.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

An information handling system may include a storage system or storage network that includes fault tolerant data storage. One example of a fault tolerant data storage system is a RAID (Redundant Array of Independent Disks) storage system. RAID storage systems combine multiple disks into an array of disk drives to obtain performance, capacity, and reliability advantages over other storage techniques, including, for example, a single large drive. Although RAID storage systems are designed and sold by several manufacturers, data compatibility between RAID storage systems from different manufacturers is limited, if not completely nonexistent. As a result, if a RAID array is created on a set of disks and a RAID controller from a first manufacturer, it is not possible to move one or more of the disks to a RAID controller from a second manufacturer and access data on the moved disks through the RAID controller of the second manufacturer. The issue of data incompatibility between RAID storage systems of different manufacturers will become more problematic as disk backup systems become more prevalent.

The use of standardized RAID configuration formats promotes the migration of RAID arrays across RAID controllers of different vendors. One example of a standardized RAID configuration format is the Common RAID Disk Data Format of the Storage Networking Industry Association (SNIA). For technical or costs reasons, however, not all vendors of RAID controllers have adopted a standardized RAID configuration. Thus, without the use of a standardized RAID configuration format, a second RAID controller may not be able to read or access the configuration information of a RAID array that was configured by a first RAID controller. In this example, the second RAID controller is not able to manage the array even though the first RAID controller and the second RAID controller are both operable to control the operation of RAID arrays having the same RAID storage algorithm, such as the RAID Level 5 storage algorithm, as one example.

### SUMMARY

In accordance with the present disclosure, a system and method is disclosed for migrating configuration information for a storage array between storage controllers. At a shutdown, a first storage controller saves its configuration information to a storage location in or associated with the storage enclosure processor of the storage array. When a second controller is coupled to the storage array, the second storage controller attempts to recognize the configuration of the storage array. If the second storage controller is not able to recognize the configuration of the storage array, the second storage controller accesses the storage location for the storage location. The second storage location confirms that the configuration stored to the storage location is associated with the disks of the storage array by comparing unique identifiers for the disks with the configuration information that is saved by the first storage controller to the storage location.

The system and method disclosed herein is technically advantageous because it provides a technique for migrating a storage array from a first storage controller to a second storage controller. In this manner, the data in the storage array can be migrated between storage controller associated with different manufacturers or providers. In addition, the placement of the storage configuration on the disk and the association between the unique identifiers for each disk and the stored storage configuration allows the configuration information be migrated between storage controller that have different formats for comparable storage methodologies. More specifically, data can be migrated between RAID controllers that may implement RAID algorithms, such as RAID Level 5, according to differing formats. Thus, the system and method disclosed herein reduces the dependency of the migration of data on the RAID format of the storage controllers involved in the migration. As such, data can be migrated between storage controllers without the necessity of each storage controller having previously adopted a defied format for a particular storage algorithm.

The system and method disclosed herein is also advantageous because it provides for logging and notifications functions in the event that the second storage controller is not able to recognize or qualify the configuration saved to the storage location. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a storage network; and

FIG. 2 is a flow diagram of a configuration discovery process.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

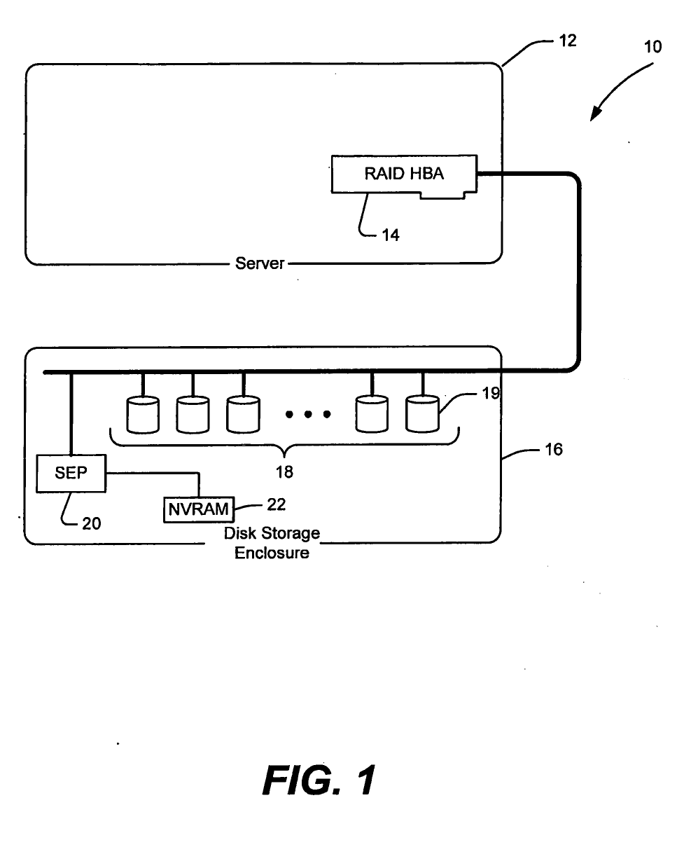

Shown in FIG. 1 is a diagram of a network 10 that includes a server 12 that is communicatively coupled to a disk storage enclosure 16. Server 12 includes a RAID host bus adapter or storage controller 14. Storage controller 14 is communicatively coupled to and manages the operation of a RAID array 18 of multiple disks 19. Also included within storage enclosure 16 is a storage enclosure processor 20, which manages the operation of the storage enclosure by communicating with the disks 19 and other components of the storage enclosure. Coupled to storage enclosure processor (SEP) 20 is a storage location 22, which in this example is identified as non-volatile random access memory (NVRAM) 22.

In operation, if RAID array 18 is configured according to a standardized RAID configuration, the configuration information concerning the configuration can be stored in storage location 22. This storage location is accessible to storage enclosure processor 20, which in turn is accessible by storage controller 14. At shutdown, the storage controller stores configuration information for RAID array 18 in storage location 22. The configuration information identifies the format of the disks of RAID array 18, including the distribution of data and configuration information on each of the disks, and the RAID algorithm, such as RAID Level 5, that is implemented across the disks of the array. In this disclosure, the first storage controller is defined as the storage controller that writes the configuration information to the storage location. The second storage controller, which is a controller that is different from the first storage controller, is defied as the controller that reads the configuration information in the storage location 22 for the purpose of migrating the data in the disks of the RAID array to permit the array to be managed by the second storage controller.

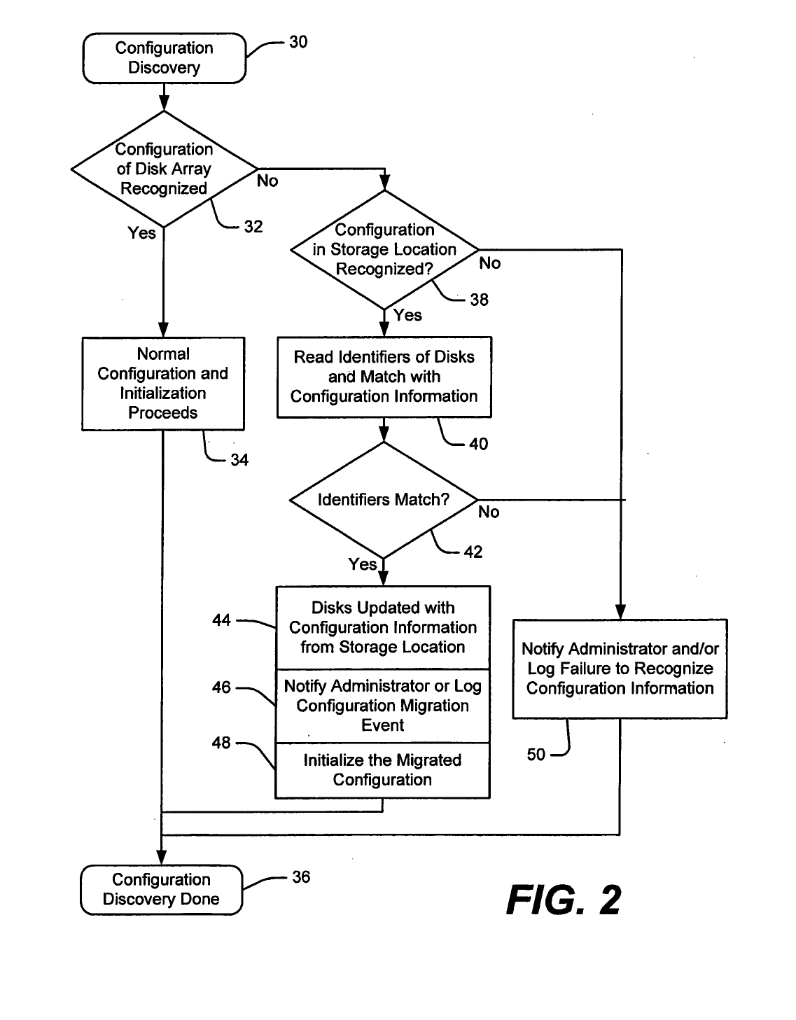

In operation, at shutdown, the first storage controller stores configuration information in a standardized format in storage location 22. Because this storage location is nonvolatile, the configuration data remains in storage location 22 even if power is removed from storage location 22. After the first storage controller stores configuration information to storage location 22 as part of a clean shutdown, a second storage controller can be coupled to disk enclosure 16. When any storage controller is coupled to the disk enclosure 16, a process known as configuration discovery is initiated. A flow diagram of the configuration discovery process is shown in FIG. 2.

After the initiation of configuration discovery at step 30, it is determined at step 32 if the second storage controller recognizes the configuration of the disk array. As part of step 32, the storage controller reads the configuration information stored on each of the disks of the array. If the storage controller recognizes the configuration from the configuration information stored on the disks of the array, then there is no need for the storage controller to consult the designated storage location 22 in disk enclosure 16. In this case, normal disk array initialization begins at step 34 and concludes at step 36. If the storage controller does not recognize the configuration from the disks of the array at step 32, then it is determined at step 38 if configuration information stored in designated storage location 22 is recognized by the storage controller. If the configuration information, if any, in the designated storage location 22 is not recognized at step 38, the administrator is notified at step 50. Step 50 may also involve the logging of the failure to recognize the configuration data in the storage location to record that the storage location contains unrecognized or missing RAID configuration data.

If, at step, 38, the second storage controller recognizes the RAID configuration information the designated storage location 22 in the disk enclosure, the storage controller next reads the world wide names (WWNs) of each of drives of the RAID array and attempts at step 40 to match the drives to WWN identification data included in the storage location. A WWN is a 64-bit address that is used to uniquely identify each element of a storage network. As an alternative to using WWNs to uniquely identify the drives of the array and correlate those drives to the configuration information in the storage location, other forms of unique identification, such as Universal Unique Identifiers, could be used. At step 42, it is determined if the unique identifiers of the drives of the array match the unique identifiers in the storage location 22. If the unique identifiers of the drives do not match the unique identifiers in the storage location, the flow diagram jumps to step 50, and the administrator is notified and the failure to recognize the configuration information in the storage location is logged.

If the unique identifiers of the drives do match the unique identifiers included in the configuration information in the storage location, a series of steps are performed to configure the drives of the array with the configuration information included in the storage location. At step 44, the disks of the array are updated with the RAID configuration information included in the storage location. At step 46, the administrator is notified or an event is logged concerning the RAID configuration migration event. At step 48, the RAID array, with the migrated configuration data, is initiated.

It should be recognized that the system and method disclosed herein is not limited in its application to an array of disks that includes on a single RAID volume. Rather, standardized configuration information concerning the multiple volumes of the disks of the array can be stored in the storage location, and this configuration information can be recognized by a second storage controller for the purpose of migrating the content of the disks of the array to a second storage controller. It should also be recognized that this disclosure is not limited in its application to a RAID storage methodology. Rather, the system and method disclosed herein may be employed with any storage methodology that involves the of standardized storage configurations. Although the present disclosure has been described in detail, it should be understood that various changes, substitutions, and alterations can be made hereto without departing from the spirit and the scope of the invention as defined by the appended claims.

What is claimed is:

1. A method for performing configuration discovery in a storage array, comprising:
by the storage controller, reading configuration information stored on the disks of the storage array to determine if the configuration of the disks of the storage array is recognized;
if the configuration of the disks of the storage array is not recognized, reading configuration information stored in a storage location in a storage enclosure associated with the disks of the storage array, wherein the storage location is separate from the disks of the storage array; and
if the configuration stored in the storage location is recognized, update the configuration of the disks in compliance with the configuration information stored in the storage location.

2. The method for performing configuration discovery in a storage array of claim 1, wherein the storage location comprises non-volatile memory.

3. The method for performing configuration discovery in a storage array of claim 1, wherein the storage array comprises a RAID storage array.

4. The method for performing configuration discovery in a storage array of claim 1, further comprising the step of, if the configuration information stored in the storage location is recognized, comparing a unique identifier read from each of the disks to configuration information stored in the storage location.

5. The method for performing configuration discovery in a storage array of claim 4, wherein the unique identifier read from each of the drives is the World Wide Name associated with each of the drives.

6. The method for performing configuration discovery in a storage array of claim 1, further comprising the step of issuing a notification if the configuration stored in the storage location is not recognized by the storage processor.

7. The method for performing configuration discovery in a storage array of claim 1, wherein the storage controller is able to access the storage location of the storage enclosure through a storage enclosure processor in the storage enclosure.

8. The method for performing configuration discovery in a storage array of claim 1,
wherein the storage location comprises non-volatile memory; and
wherein the storage array comprises a RAID storage array.

9. The method for performing configuration discovery in a storage array of claim 8, further comprising the step of, if the configuration information stored in the storage location is recognized, comparing a unique identifier read from each of the disks to configuration information stored in the storage location.

10. A network, comprising:
a storage enclosure, wherein the storage enclosure includes a storage location and a storage array comprised of a plurality of disks, wherein the storage location is separate from the storage array;
a server, wherein the server includes a storage controller that is communicatively coupled to the disks of the storage array, wherein the storage controller is operable to perform a configuration discovery process, comprising:
reading configuration information stored on the disks of the storage array to determine if the configuration of the disks of the storage array is recognized;
if the configuration of the disks of the storage array is not recognized, reading configuration information stored in a storage location in a storage enclosure associated with the disks of the storage array, wherein the storage location is separate from the disks of the storage array; and
if the configuration stored in the storage location is recognized, update the configuration of the disks in compliance with the configuration information stored in the storage location.

11. The network of claim 10, wherein the storage location comprises non-volatile memory.

12. The network of claim 10, wherein the storage array comprises a RAID storage array.

13. The network of claim 10, wherein the storage controller is operable to compare a unique identifier read from each of the disks to configuration information stored in a storage location if the configuration information stored in the storage location is recognized.

14. The network of claim 13, wherein the unique identifier read from each of the drives is the World Wide Name associated with each of the drives.

15. The network of claim 10, wherein the storage controller is operable to issue a notification if the configuration stored in the storage location is not recognized by the storage processor.

16. A method for migrating the array configuration from a first storage controller to a second storage controller, wherein the first storage controller is coupled to a storage array comprising:
by a first storage controller, saving configuration information concerning the configuration of the storage array to a storage location in a storage enclosure associated with the storage array, wherein the storage location is separate from the storage array;
replacing the first storage controller with the second storage controller;
by the second storage controller,
reading configuration information stored on the disks of the storage array to determine if the configuration of the disks of the storage array is recognized;
if the configuration of the disks of the storage array is not recognized, reading configuration information stored in a storage location in a storage enclosure associated with the disks of the storage array, wherein the storage location is separate from the disks of the storage array; and
if the configuration stored in the storage location is recognized, update the configuration of the disks in compliance with the configuration information stored in the storage location.

17. The method for migrating the array configuration from a first storage controller to a second storage controller of claim 16, wherein the storage location comprises non-volatile memory.

18. The method for migrating the array configuration from a first storage controller to a second storage controller of claim 16, wherein the storage array comprises a RAID storage array.

19. The method for migrating the array configuration from a first storage controller to a second storage controller of claim 16, further comprising the step of, by the second storage controller, comparing a unique identifier read from each of the disks to configuration information stored in the storage location if the configuration information stored in the storage location is recognized.

20. The method for migrating the array configuration from a first storage controller to a second storage controller of claim 16, wherein the unique identifier read from each of the drives is the World Wide Name associated with each of the drives.
